(19) United States
(12) Patent Application Publication
(10) Pub. No.: US 2026/0153114 A1
(43) Pub. Date: Jun. 4, 2026

(54) A PLASTIC PIN

(71) Applicants: STANDARD PROFIL EGE OTOMOTIV SANAYI VE TICARET ANONIM SIRKETI, Kagithane, Istanbul (TR); STANDARD PROFIL SPAIN S.A., Logrono, La Rioja (ES)

(72) Inventor: Víctor Pascual TUDELILLA, Logroño Salamanca (ES)

(21) Appl. No.: 19/123,110

(22) PCT Filed: Jan. 25, 2023
(86) PCT No.: PCT/TR2023/050059

§ 371 Date: Apr. 22, 2025

(51) Int. Cl. B25C 3/00; F16B 21/12

(52) U.S. Cl. CPC F16B 21/10

(57) ABSTRACT

Disclosed is a plastic pin that has good insertion/retention properties in holes created in car parts. The plastic pin has a design able to be assembled and disassembled up to 3 times with minimal loss in performance.

### TECHNICAL FIELD

The present disclosure relates to a plastic pin that has good insertion/retention properties in the holes created in the car parts, and with a correct design to be able to assemble and disassemble up to 3 times with minor loose on performance.

### BACKGROUND

Plastic panel pins are ideal to fasten car panels. These plastic panel clips can be used in diverse applications: car trim clips, panel wall clips, board clips, car body panel fixings, car door retainers, weatherstrip retainers, wheel arch/fender clips, tailgate light clips, panel under bonnet rivets, fastening rubber side door etc.

Users are demanding parts that could be removed from the car during the assembly process in the production plants. In some cases, they use clips that can be used several times with small loose on performance. When the clips need to be used inside TPE mouldings, it is necessary to have good compromise between bonding on the moulding and performance with good retention on the sheet metal. With current clips, cannot warranty both requests either the clip is detached from the TPE moulding or the clip damages completely after extraction from sheet metal and the part could not be used anymore. This means that an expensive part cannot be reused just because one pin is permanently damaged.

The application numbered CN106696876A in the state of the art relates to an assembly method of vehicle bumper support, support body and fixing pin. However, in the said application does not mention the plastic pin that has good insertion/retention properties in the holes created in the car parts.

In conclusion, the drawbacks explained above and the shortcomings in existing solutions to the problems have necessitated improvement in the related technical field.

### SUMMARY OF THE INVENTION

The present invention relates to a plastic pin that has good insertion/retention properties in the holes created in the car parts.

The primary aim of the invention is to provide a pin that has good insertion/retention properties in the holes created in the car parts.

In order to achieve the aims, set out above and in the detailed explanation below, a plastic pin that has good insertion/retention properties in the holes created in the car parts, characterized by comprising; a plastic pin ensures that insertion/retention in the holes created in the car parts and a PP spacer located between the plastic pin and the car parts and provide connecting the plastic pin to the car parts.

Necessary to have good bonding properties on the TPE moulding, need to use materials with good adhesion and compatible with those injection materials. At the same time, it is necessary to have good properties for the hooks of the plastic pins to guarantee that they are not deformed too much during extraction. This leads into a pin made out of 2 different pieces/materials that are assembled together before introducing it inside the TPE mould.

The below drawings and the detailed description set out with reference to the accompanying drawings provide for a clearer understanding of the structural and characteristics properties and all benefits of the present invention; therefore, the evaluation needs to take these drawings and the detailed description into account.

### BRIEF DESCRIPTION OF THE DRAWING

FIG. 1 shows representative a plastic pin.

FIG. 2 shows representative a plastic pin.

FIG. 3 shows representative a plastic pin.

FIG. 4 shows representative a plastic pin.

The figures are not required to be scaled and the details which are not necessary for understanding the present invention may be neglected.

### DESCRIPTION OF THE PART REFERENCES

1. Moulding
2. PP spacer
3. Plastic pin

### DETAILED DESCRIPTION

The present invention relates to a plastic pin (3) that has good insertion/retention properties in the holes created in the car parts, and with a correct design to be able to assemble and disassemble up to 3 times with minor loose on performance.

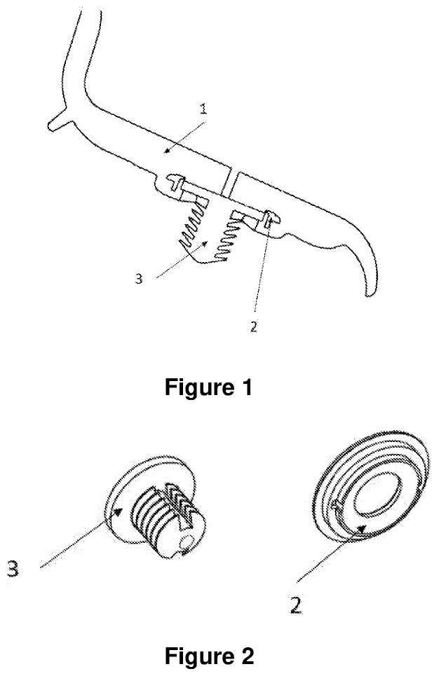

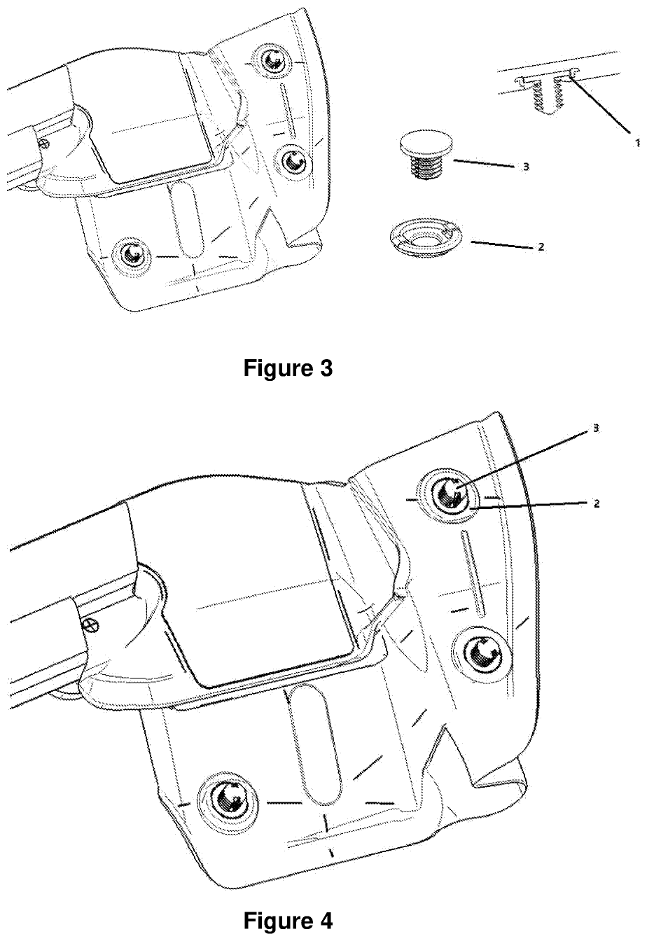

Plastic pin (3) fasteners are typically utilized to secure two members, together, such as two panels or the like, and include a head and a shank. A plastic pin (3) fastener of the improved variety contemplated by the present invention is designated by the numeral 3 and includes a pp spacer (2) and a moulding plate (1). Such a plastic pin (3) fastener, as contemplated by the present invention, can have a pp spacer (2) used to fasten trim panels to automotive parts. An embodiment of such a plastic pin (3) fastener is shown in FIG. 1.

Moulding (1) plate is TPE. Moulding (1) is necessary to cover the sheet metal and add sealing performance in contact with glass or sheet metal. For this reason, it must be firmly attached to a support part on the car (sheet metal or plastic parts). PP (plastic pipe) spacer is made in a material compatible, TPE (Thermoplastic elastomer), with good bonding properties. Plastic pin (3) is that has good insertion/retention properties in the holes created in the car parts, and with a correct design to be able to assemble and disassemble up to 3 times with minor loose on performance.

1. A plastic pin that has good insertion/retention properties in holes created in TPE moulding to cover sheet metal car parts, the plastic pin comprising:
a plastic pin ensures that insertion/retention in the holes created in the car parts; and
a PP spacer located between the plastic pin and the car parts and connects the plastic pin to the car parts.
